(19) United States
(12) Patent Application Publication
(10) Pub. No.: US 2023/0340980 A1
(43) Pub. Date: Oct. 26, 2023

(54) Tripod Leg Locking System

(71) Applicant: JEFFREY OVERALL, COSTA MESA, CA (US)

(72) Inventor: Tyler Wilson, Huntington Beach, CA (US)

(73) Assignee: Polar Pro Filters, Inc., COSTA MESA, CA (US)

(21) Appl. No.: 17/726,310

(22) Filed: Apr. 21, 2022

(51) Int. Cl. F16B 7/10; F16M 11/32

(52) U.S. Cl. CPC F16B 7/105; F16M 11/32

(57) ABSTRACT

A tripod leg locking system enabling the distal locking of a tripod leg. A rod extending the length of a leg segment enables manual activation of the lock at the top of the leg, while the locking force is applied at the bottom of the leg segment.

### FIELD OF INVENTION

The invention relates to tripod legs. Specifically, it relates to a tripod leg locking system enabling distal locking of a tripod leg, thereby allowing the lock activation mechanism to be located relatively higher up on a tripod leg.

### BACKGROUND

Traditional multi-segment tripod legs use a variety of locking means, such as clamps and lever locks, which create friction locks at the bottom of each leg section to secure the leg segments at a desired length. Because the traditional locking means generate locking force directly on an adjacent surface of the tripod leg, they must be located at the bottom of the leg segment, to create the most efficient locking orientation. Such positioning the locks at the bottom of the leg segments make the locks more difficult to access and manipulate.

### SUMMARY

The present invention provides a locking system capable of distal locking of a tripod leg segment. A switch couples with a rod, which extends along the length of a first leg segment towards an angled bushing. A biasing device couples at the opposing end of the rod. The switch can be manipulated into a locked position, in which the biasing device engages and forces the angled bushing into the second leg segment, thereby creating a friction fit lock, in which the legs are held stationary relative to each other.

This distal locking ability enables the switch to be placed at the top of the leg, where it is more easily manipulated, while the locking force may be exerted at a distal, more optimal position of the leg. The switch and biasing device may be oriented so that movement of one causes oblique or perpendicular of the other. This enables lateral movement of the switch to cause vertical movement of the biasing device downward to create a distal lock.

### BRIEF DESCRIPTION OF THE DRAWINGS

FIG. 1A depicts a tripod in a closed position with legs retracted.

FIG. 1B depicts a tripod in an open position with the legs retracted.

FIG. 1C depicts a tripod in an open position with a second segment and third segment extended.

FIG. 2 is a front view of a tripod leg, a second segment and third segment and aspects of the first segment exploded.

FIG. 3A is a front view of an isolated locking system in an unlocked position.

FIG. 3B is a left side view of an isolated locking system in an unlocked position.

FIG. 3C is a front view of an isolated locking system in a locked position.

FIG. 3D is a left side view of an isolated locking system in a locked position.

FIG. 4A is a front view of a leg fully retracted and in an unlocked position.

FIG. 4B is a left side sectional view of a leg fully retracted, taken from FIG. 4A.

FIG. 4C is a front view of a leg fully retracted and in an locked position.

FIG. 4D is a left side sectional view of a leg fully retracted, taken from FIG. 4C.

FIG. 5 is a bottom left perspective view of locking system components and a leg rotation system.

FIG. 6A is a top right perspective view of an isolated switch and an isolated riser block

FIG. 6B is a back view of an isolated switch and an isolated riser block.

FIG. 7 is a perspective view of an isolated tripod head.

FIG. 8 is a perspective view of an isolated tripod head exploded.

FIG. 9A is a planar view of an isolated tripod head.

FIG. 9B is a sectional view of the tripod head, taken from FIG. 9A.

FIG. 9C is a planar view of an isolated tripod head with an articulating half ball tilted.

FIG. 9D is a sectional view of the tripod head, taken from FIG. 9C.

### DRAWING NUMERALS

10 closed position
20 open position
50 slide position
60 lock position
100 Mounting system
101 Tripod head
110 Quick release attachment
120 Tilt core
130 Tilt drag knob
140 Drag ring
200 Bowl
250 Bowl knob
252 Internal knob
254 Locking knob
270 Articulating half ball
272 Half ball aperture
276 Internal half ball
280 Anchor
290 Head screw
298 Ball cap
300 Handle
350 Dial
400 Angle selector
410 Switch
412 Riser lock
413 Beveled switch surface
414 Switch locked surface
415 Switch unlocked surface
416 Riser lock locked surface
417 Riser lock unlocked surface
418 Riser lock beveled surface
420 Angle selector button
422 Angle selector pin
424 Pin spring
428 Angle selector ratchet
430 Angle selector pivot
500 Leg
510 Leg cavity
520 First segment
522 First segment tube
524 Rod
525 Rod biasing spring
526 Biasing element
528 Tube lower
530 Angled bushing
540 Second segment
542 Second segment tube
544 Second segment tube top
558 Bottom latch
560 Third segment
652 Third segment tube
564 Third segment tube top
590 Foot

### DETAILED DESCRIPTION OF THE DRAWINGS

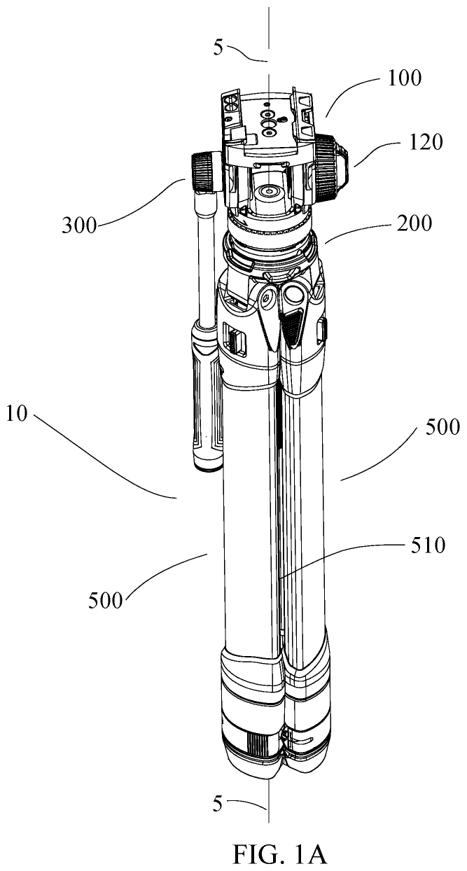

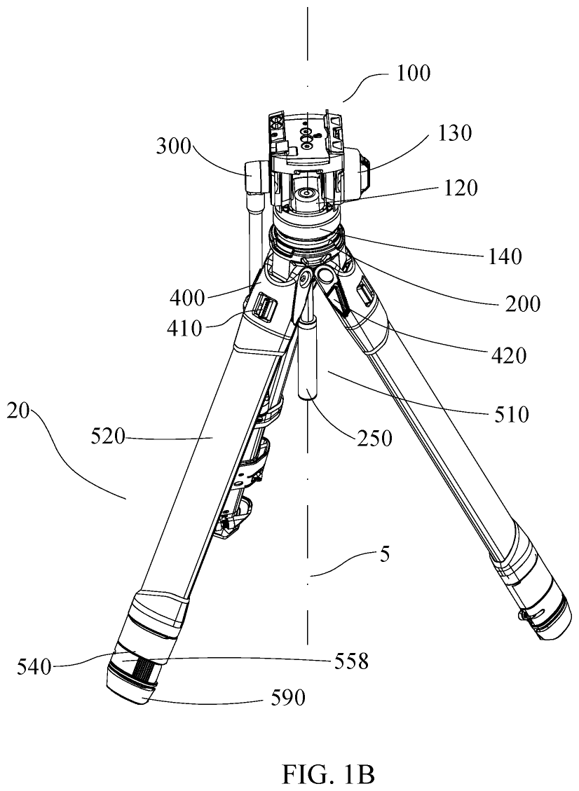

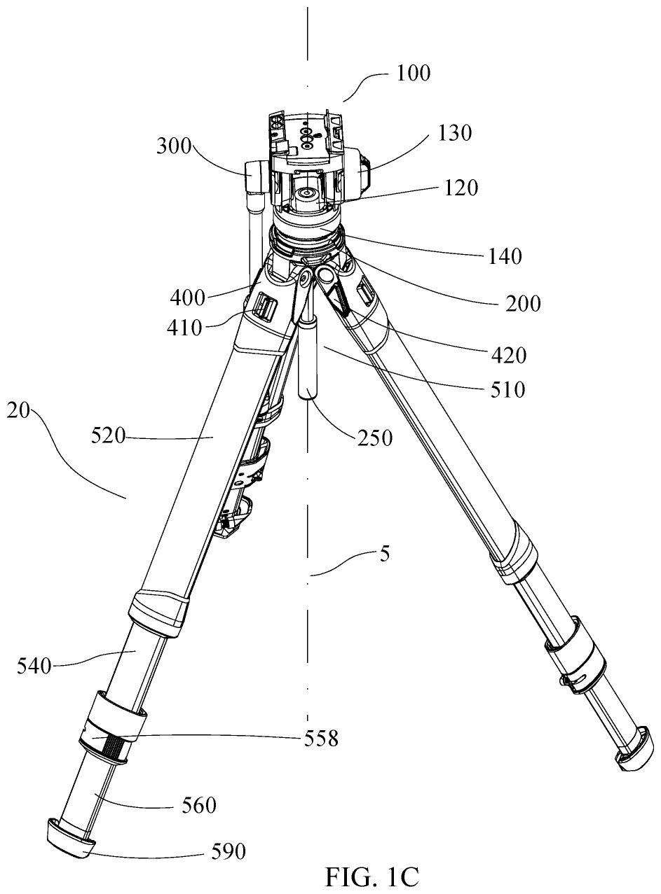

All three legs 500 may couple with a bowl 200. An articulating half ball 270 may couple a tripod head 100. The tripod head 100 may comprise a mounting system 101 as means of coupling a camera or other auxiliary device. In a closed position 10 (see FIG. 1) the legs 500 may extend roughly parallel to each other. In a closed position 10, each leg may abut the other two legs along a lengthwise edge, or there may be a small, i.e. 0.5-2 cm, space between the legs in some embodiments.

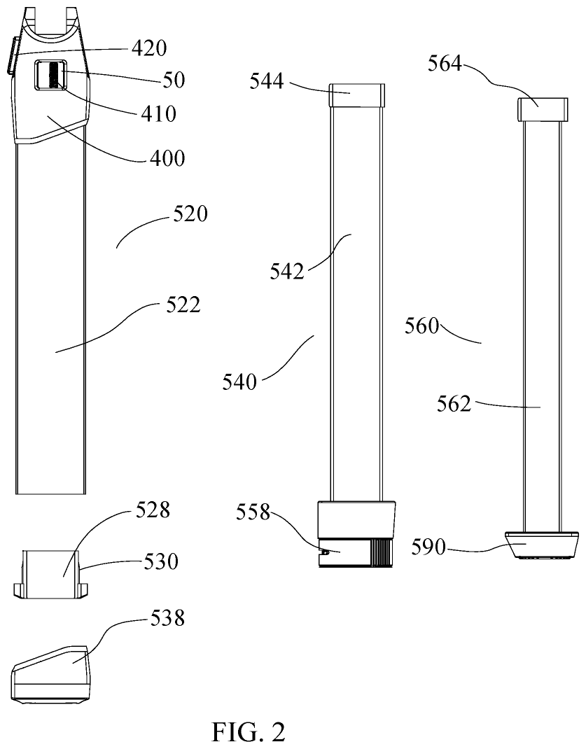

The legs 500 may pivotably couple with the bowl 200 via components of a leg rotation system. An angle selector ratchet 428 aspect of the bowl 200. An angle selector pin 422 may be inserted into the angle selector ratchet 428, enabling the leg to rotate into an open position 20 (see FIG. 2). A pin spring 424 may urge the angle selector pin 422 into a closed position 10, in which the leg cannot be rotated relative to the bowl 200. Applying a predetermined amount of force to an angle selector button 420 may urge the angle selector pin 422 out of the closed position 10 and enable rotation of the leg 500 relative to the bowl 200. References to “movement” or “rotation” of a first component “relative to” a second component means the first component can be moved while the second component remains stationary. When the force is removed from the angle selector button 420 the angle selector pin 422 may be urged back into the locked position, securing the leg 500 in the closed 10 or an open 20 position.

The legs 500 may be configured to create an intervening leg cavity 510.

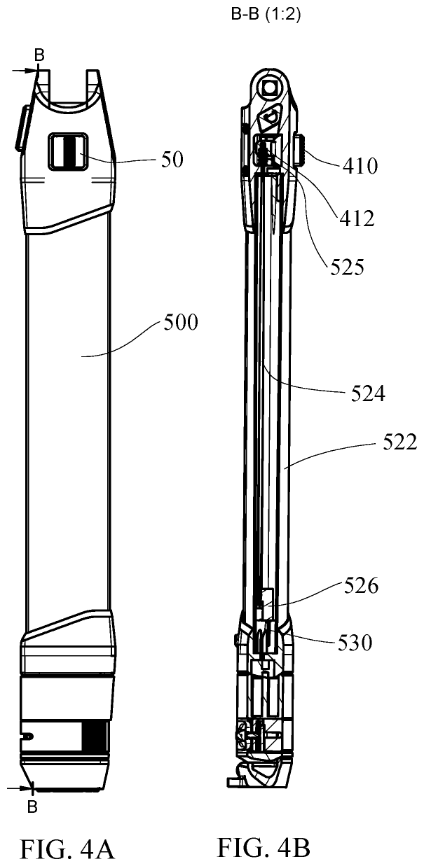

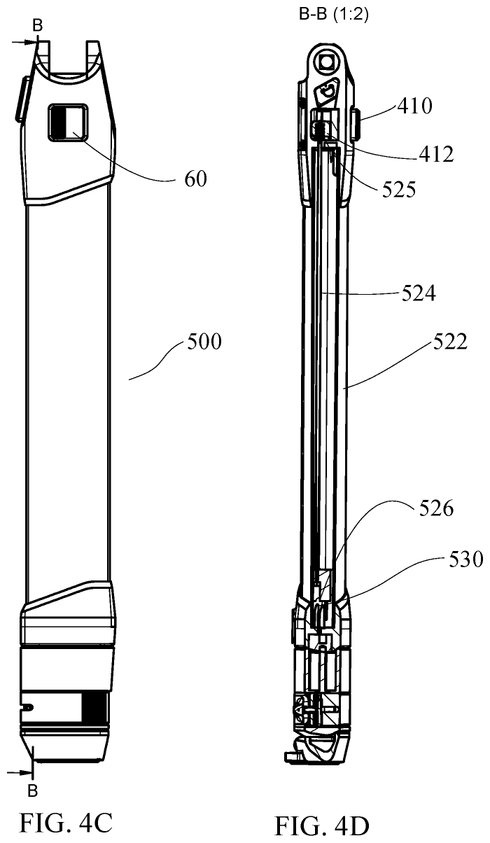

Each leg may be comprised of a first segment 520, second segment 540, and third segment 560. The second segment 540 may operatively couple with the first segment 520. “Operatively couple” means connection of the components with the ability to at least one component to move relative to another. The third segment 560 may operatively couple with the second segment 540. The second 540 and third segment 560 may extend from and retract up into the adjacent segment (520, 540; see FIGS. 1B-C). A second segment tube top 544 may prevent the second segment from dislodging from the first segment 520 (see FIG. 4). A third segment tube top 564 may prevent the third segment 560 from dislodging from the second segment 540.

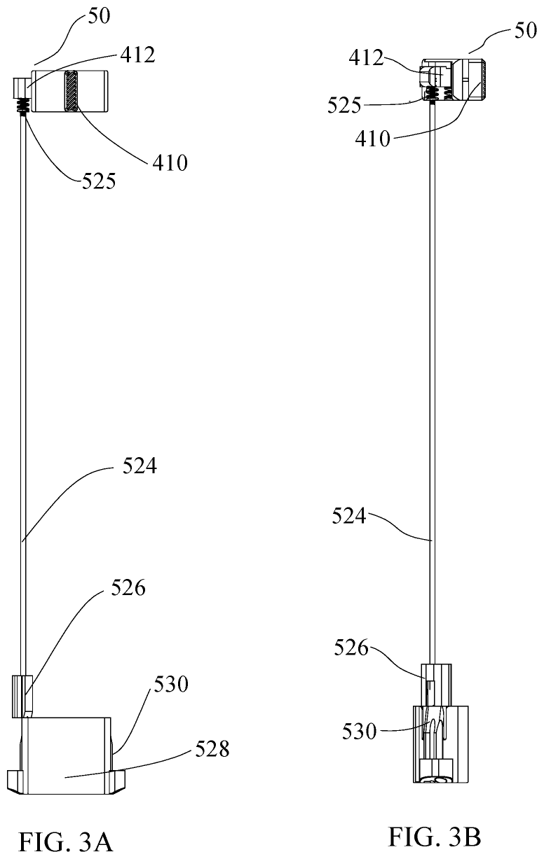

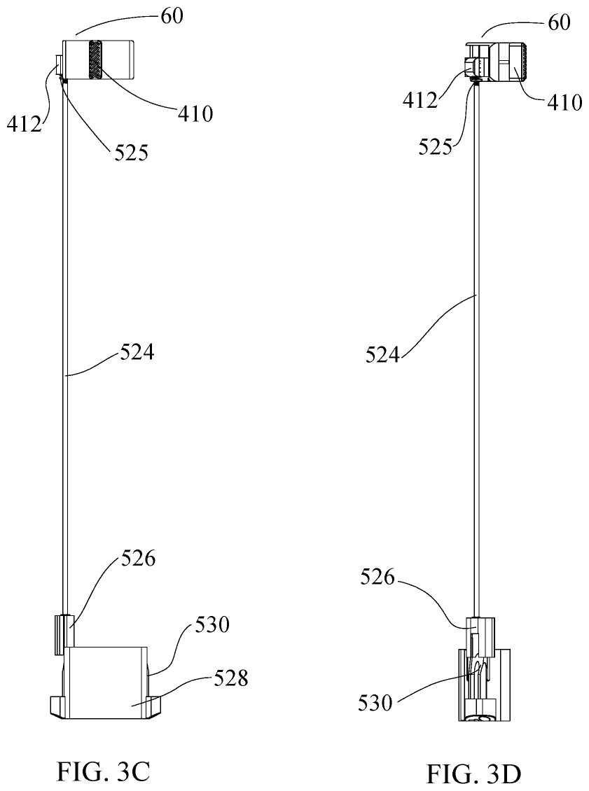

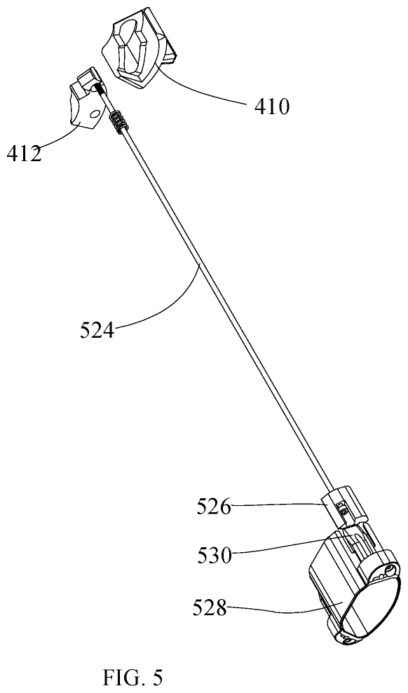

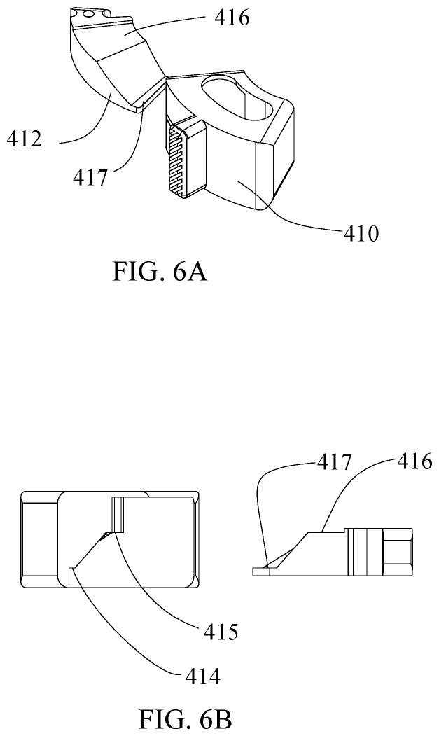

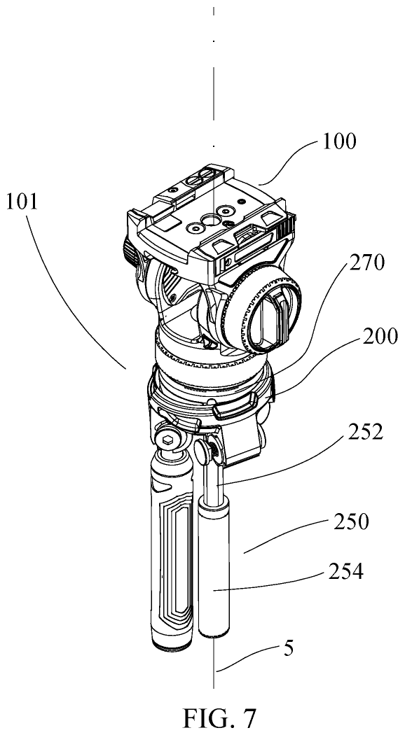

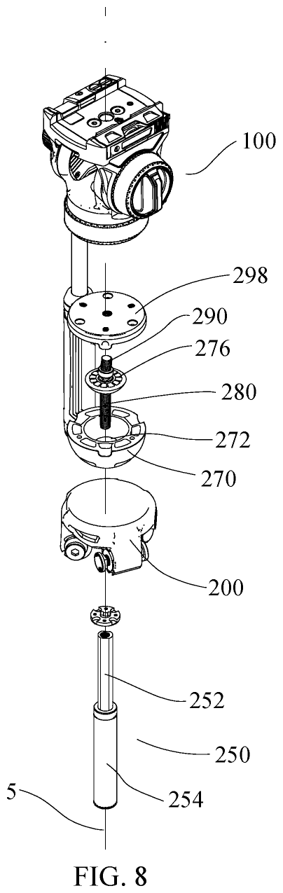

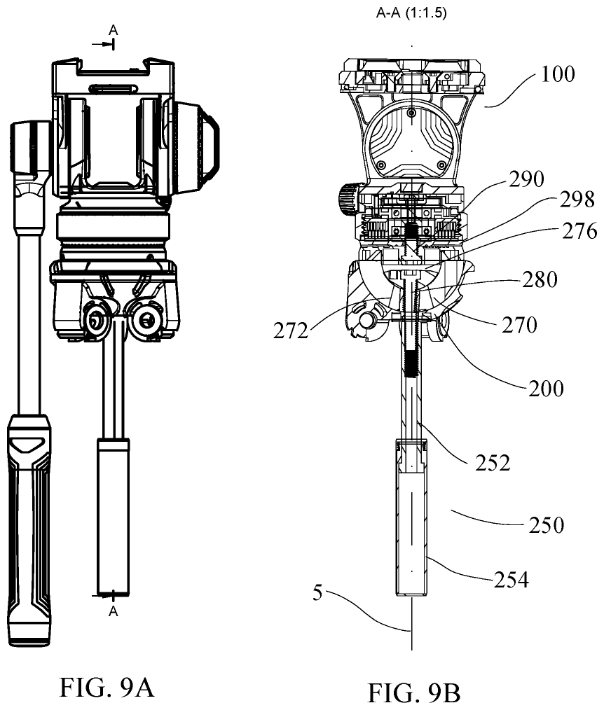

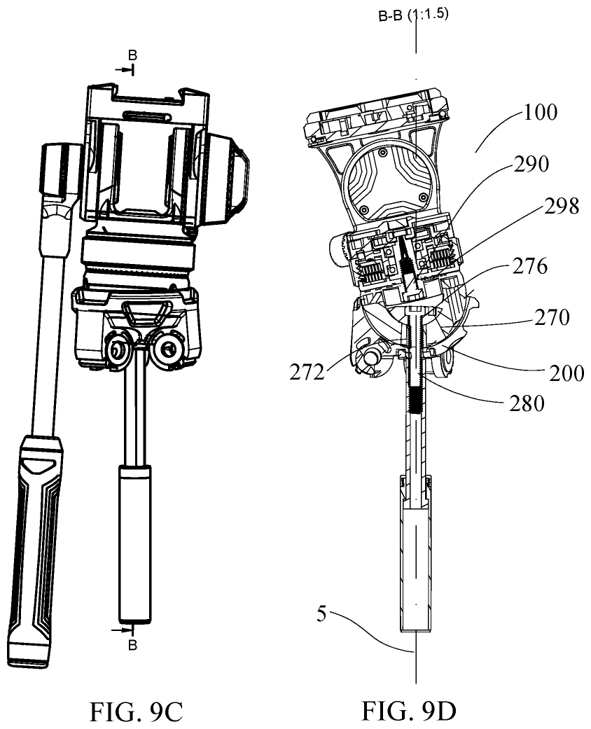

The first segment 520 may house locking system components. A rod 524 may be housed within the first leg segment 520, between the first segment tube 522 and second segment tube 542 (see FIGS. 4B and 5B). At a top end, the rod 524 may couple with a riser lock 412, and a biasing element 526 at a bottom end (see FIGS. 3A-D). A rod biasing spring 525 may urge the riser lock 412 up into an unlocked position 50. The rod biasing spring 525 may be disposed between the riser lock 412 and another surface relative to which the riser lock 412 moves. The riser lock 412 may abut or engage a switch 410. The switch 410 is accessible through an opening in the angle selector 400. The switch 410 may be manually moved out of the unlocked position into a locked position 60 (see FIGS. 3A-3B). In the exemplary embodiment, the switch 410 is moved laterally to adjust the switch 410—and locking system as a whole—from a locked 60 to an unlocked position 50. Interfacing surfaces of the riser lock 412 and switch 413 may be beveled so that transverse movement (rotation) of the switch left may force the riser lock 412 down, towards tube lower 528 aspect of the first segment 520 (see FIGS. 6A-B). The switch 410 may comprise a locked 414 and an unlocked surface 415, with an intervening beveled switch surface 413. The riser lock 412 may comprise corresponding locked 416, unlocked 417, and beveled 418 surface(s). In an unlocked position 50 the unlocked surfaces (414, 417) may abut, making it impossible to move out of the unlocked position without moving the switch 410 laterally. Movement of the switch 410 from the unlocked position 50 may cause engagement of the beveled surfaces (413, 418). The riser lock 412 is forced downward, until the locking surfaces (415, 416) abut and secure the locking system into a locked position 60.

The switch 410 and riser lock 412 may be comprised of aluminum or other metal or rigid material. The rod 524 may be comprised of steel and the biasing device 526 made of aluminum. The tube lower 528 and it's angled bushing aspect 530 may be comprised of a polyoxymethylene, another thermoplastic or another material enabling the requisite pliability.

The switch 410 may be rotated into a lock position 60. In a lock position 60 the riser lock and rod are forced against an angled bushing 530 aspect of the tube lower. The tube lower 528 sleeves the second segment tube 542, allowing it to pass through when the switch 410 is in a slide position 50. In a locked position 60, the rod forces the biasing element 526 down into the angled bushing 530. The interfacing surfaces of the biasing element 526 and angled bushing 530 may be beveled so that downward movement of the biasing element forces the angled bushing inward toward the second segment tube 542. In a locked position 50, the angled bushing 530 engages the second segment tube 542, locking it in position.

The third segment 560 may extend from the second segment 540. The second segment 540 may contain locking means enable the third segment 560 to be locked relative to it. A bottom latch 558 may serve as the locking means.

An articulating half ball 270 may be disposed between the bowl 200 and the tripod head 100. The articulating half ball 270 may be hemispherical and bowl shaped, with a recess in which an internal half ball 276 may be disposed. An anchor 280 couples with the internal ball and extends downward, through a half ball aperture 272 in the articulating half ball 270 and through an opening in the bowl 200. The anchor 280 connects with an internal knob 252 aspect of a locking knob 254.

A ball cap 298 aspect of the articulating half ball 270 may couple with the tripod head 100. A head screw 290 may couple the tripod head 100 and ball cap 298. The articulating half ball 270 is capable of movement relative to a tilt axis 5. The half ball aperture 272 may be configured to enable a certain tilt range which is limited by the articulating half ball 270 contact with the intervening anchor 280. The ball cap 298 and the tripod head 100 tilt with the articulating half ball 270, moving independently of the bowl 200, internal ball 276 and anchor 280. The ball cap 298 may be an integral aspect of the articulating half ball 270, or a modular component coupled the articulating half ball 270 via screws or other means. The ball cap 298 may be made of aluminum, another metal or thermoplastic. The internal ball 276 and articulating half ball 270 may be comprised of polyoxymethylene or other thermoplastic. The bowl 200 may be comprised of aluminum. The internal knob 252 may be comprised of steel or other metal or thermoplastic. The locking knob 254 may be comprised of aluminum or other metal or thermoplastic.

The bowl knob 250 may enable adjustment of the internal ball 276 to a plurality of tilt orientations relative to the tilt axis 5. In the tilt position, the internal ball 276 is disengaged from the articulating half ball 270, enabling the articulating half ball 270 to move relative to the tilt axis 5, as discussed above. Rotation of the locking knob 254 aspect of the bowl knob 250 around the tilt axis 5, may move the anchor 280, and in turn the internal ball 276 downwards into engagement with the articulating half ball 270. When a predetermined amount of pressure is exerted on the articulating half ball 270, it is locked between the internal ball 276 and bowl 200, thereby establishing the stable position. Rotation of the bowl knob 250 in the opposite direction may move the internal ball 276 in the opposite direction, into a tilt position.

A bowl knob 250 may extend into the leg cavity 510. Because the bowl knob 250 remains stationary along the tilt axis 5, the legs may be oriented into the closed 10 position around it. Any tilt position may be maintained with the legs irrespective of leg 500 orientation.

The foregoing discussion discloses and describes merely exemplary methods and embodiments. As will be understood by those familiar with the art, the disclosed subject matter may be embodied in other specific forms without departing from the essence or characteristics thereof. Accordingly, the foregoing disclosure is intended to be illustrative, but not limiting, of the scope of the invention, which is set forth in the claims.

I claim:

1. A extendable leg locking system, comprising:
a. a first segment and a second segment the second segment being operatively coupled with the first segment, and housed partially therein;
b. the first segment housing a switch and riser lock, the riser lock and the switch comprising interfacing surfaces beveled so that movement of the switch on one plane results movement of the riser lock on a different, non-parallel plane;
c. the riser lock coupling with a rod, the rod extending along the length of the first segment, and coupling with a biasing element;
d. the first segment housing an angled bushing;
e. the switch being accessible and capable of a locked position, wherein the switch is rotated into the riser lock, whereby the biasing element is urged into the angled bushing, urging the angled bushing into the second segment, thereby creating a friction lock;
f. the switch being capable of an unlocked position, wherein the switch is rotated out of the locked position, enabling a rod biasing spring to urge the riser lock away from the angled bushing, wherein the biasing device disengages from the angled bushing, thereby enabling the second leg to move relative to the first segment.

2. The extendable leg locking system in claim 1, wherein the switch and riser lock each comprise locking surfaces, switch and riser lock surfaces engaging in both the locked and unlocked positions, and preventing adjustment out a locked or unlocked position other than by movement of the switch in a direction parallel to the engaged locking surfaces.

3. A tripod leg, comprising:
a. a first leg segment operatively coupling a second leg segment;
b. a locking system, comprising a switch, a riser lock, a rod, a biasing element, and a tube lower;
c. the switch and riser lock comprising interfacing surfaces configured so that movement of one component causes oblique movement of the other;
d. the riser lock being located at the top half of the first segment and coupling with a rod;
e. the biasing device being located at the bottom half of the first leg segment, and the biasing device coupling with the rod;
f. the locking system being capable of a locked position, in which the switch is oriented to exert force on the riser lock, whereby the biasing device is forced into the tube lower with sufficient force to exert friction locking force on the second leg segment;
g. the locking system being capable of an unlocked position, in which the switch is oriented so that the tube lower does not exert a friction locking force on the second leg segment, whereby the second leg segment may be moved relative to the first leg segment.

4. The tripod leg in claim 3, wherein a rod biasing spring urges the riser lock towards the unlocked position.

5. A tripod leg, comprising:
a. a first leg segment operatively coupling a second leg segment;
b. a locking system, comprising a switch, a riser lock, a rod, and a biasing element;
c. the switch and riser lock comprising interfacing surfaces configured so that movement of one component causes oblique movement of the other;
d. the riser lock being located at the top half of the first segment and coupling with a rod;
e. the biasing device being located at the bottom half of the first leg segment, and the biasing device coupling with the rod;
f. the locking system being capable of a locked position, in which the switch is oriented to exert force on the riser lock, whereby the biasing device is engages the second leg segment with sufficient force to exert friction locking force on the second leg segment;
g. the locking system being capable of an unlocked position, in which the switch is oriented so that the biasing device does not exert a friction locking force on the second leg segment, whereby the second leg segment may be moved relative to the first leg segment.

6. The tripod leg in claim 5, wherein a rod biasing spring urges the riser lock towards the unlocked position.
